(19) United States
(12) Patent Application Publication
(10) Pub. No.: US 2011/0092254 A1
(43) Pub. Date: Apr. 21, 2011

(54) Electronic Communication Device with two Input Devices

(75) Inventors: Nikolaj Bestle, Denmark (DK); Niels Peter Emme, Hellerup (DK)

(73) Assignee: NOKIA CORPORATION, Espoo (FI)

(21) Appl. No.: 12/445,940

(22) PCT Filed: Oct. 16, 2006
(86) PCT No.: PCT/IB06/53802

§ 371 Date: Nov. 12, 2010

(51) Int. Cl. H04W 88/02; H04M 1/73

(52) U.S. Cl. 455/566; 455/575.4; 455/574

(57) ABSTRACT

The present invention provides a mobile telephone handset having a first input device disposed on a main body portion of the handset. A second body portion is moveably mounted on the first body portion and can be moved between an open and closed position with respect to the main body portion, such that when in a open position the first input device is exposed for use by a user. In addition, an first input device is provided and is arranged to be moveable between an inactive and operational position with respect to the main body portion when the second body portion is in the open position.

The present invention relates to an electronic communication device, such as a mobile phone handset, having input means, such as a keypad, for inputting data or commands into the device. In particular, the present invention relates to a mobile phone handset having at least two means for inputting data or commands.

Embodiments of the present invention are described herein with reference to mobile phone handsets. However, the invention is not limited mobile phones and can be applied to any type of electronic communication device, such as a personal digital assistant (PDA), portable two-way radio set, or the like.

Electronic communication devices, such as mobile phone handsets, are well known, and are designed with many different configurations. Handsets having two or more body portions arranged to be moveable with respect to one another provide a relatively compact handset. When a user wishes to operate such a phone, the two portions of the handset can be moved apart to expose a keypad. The handset can be in a folding configuration (so-called “flip-phone”, for example the Nokia® 6125 or 9500) or in a sliding configuration (so-called “slide-phone”, for example the Nokia® 8800 or N72).

EP813328A2 describes a removable cover for use with a personal communicator of the type having a touch screen display.

EP1263192A2 describes a compact computer device which may comprise a mobile telephone or game and which is provided with a display screen and a full function keypad for use as a personal information manager or the like.

PDA devices are known and generally comprise a display screen, a keypad and stylus or pen, which can be used to input commands from the user, via the display screen, into the PDA. Typically, the stylus is stored in a cavity disposed in the housing of the PDA and is manually removed from the cavity when the user requires.

It is an aim of the present invention to provide an electronic communication device having at least two means by which data or commands can be input to the device. Furthermore, the present invention aims to provide a relatively compact device having the at least two input means.

More specifically, the present invention provides an electronic device, comprising; a main body portion, a first input device arranged to be moveable relative to the main body portion between an operative and an inoperative position, a second body portion moveable with respect to the main body portion between an open and closed position, and a second input device arranged to be exposed for use when the first input device is in an inoperative position and the second body portion is in an open position. As a result, the input pad can be moved into an operational position when the second body portion is in the open position. This provides a robust handset configuration.

Alternatively, the present invention provides a manually operable portable wireless electronic communication device, such as a mobile phone terminal or handset, comprising; a keypad disposed on a main body portion of the device, a second body portion moveable between an open and closed position with respect to the main body portion, such that when in a open position the keypad is exposed for use by a user, and an input pad arranged to be moveable between an inactive and operational position with respect to the main body portion when the second body portion is in the open position. As a result, the first input means can be moved into an operational position when the second body portion is in the open position. This provides a robust handset configuration.

Preferably, the first input device can be disposed on the main body portion. Alternatively, the first input device can be disposed on the second body portion. In addition, the second input device can be a keypad disposed on the main body portion. Furthermore, the first input device can be a touch-sensitive input device. Thus, the functionality of a handset is increased or improved.

Preferably, a stylus for inputting data or commands to the device via the first input device can be provided. The stylus can be arranged to be disposed in a body portion of the device, the stylus being moveable with respect to the device between a stowed position and a release position when the first input device is in the operative position, and wherein at least a portion of the stylus extends from the device when the stylus is in the release position. Thus, the stylus is arranged for easy manual removal from the device.

Preferably, a mechanism is provided for moving the stylus, the mechanism being coupled to the stylus and to the first input device, and being arranged so that movement of the first input device from the inoperative position causes the stylus to move from the stowed position. Thus, the stylus is automatically extended from the device for manual use when the first input pad is moved into the operational position, thereby improving the ease of use of the device.

Preferably, the first input device is disposable over the second input device when the first input device is in the operative position. Thus, the input pad is supported by the keypad during use thereby providing a robust configuration.

Preferably, a manually operated actuator coupled to the second body portion can be provided, such that operation of the actuator causes the second body portion to move to the open position. Thus, the handset can be moved automatically into an open configuration by use of a switch.

Preferably, the actuator is moveable between a first position and a second position, and between a first position and a third position, such that when the actuator is moved from the first to the second position, the second body portion is arranged to move to the open position with the first input device in the inoperative position, and when the actuator is moved from the first to third positions, the second body portion is arranged to move to the open position with the first input device in the operative position. Thus, the user can determine into which configuration the device opens, either with the keypad exposed, or with the input pad (and possibly the stylus, in addition) exposed for use.

Preferably, the actuator is a bi-directional switch arranged so that the first position corresponds to a relaxed position, and the second and third positions are disposed either side of the relaxed position. This arrangement also provides an easy to use configuration.

Preferably, a sensor can be arranged to determine whether the first input device is in the operative position. The sensor can be arranged to provide a signal when the first input device is in the operative position, said signal being usable for the moving of the stylus from the stowed position. Thus, automated release of the stylus is achievable. Furthermore, the signal from the sensor can be used by other components of the device that require an indication as to the disposition of the input pad.

Preferably, a controller is arranged to control the flow of data from the first and second input device such that only first input device data is forwarded by the controller when the first input device is in the operative position.

Preferably, or as an alternative, a controller is arranged to supply electrical power to the first and second input device such that power is only supplied to the first input device when the first input device is in the operative position.

Furthermore, the present invention provides a method of operating an electronic device, said device comprising a first input device, a main body portion, a second body portion moveable with respect to the main body portion between an open and closed position, such that when in the open position the first input device is moveable relative to the main body portion between an operative and an inoperative position, and a second input device arranged to be exposed for use when the first input device is in an inoperative position and the second body portion is in an open position; the method comprising, determining whether the first input device is in the inoperative or operative position, if the first input device is in the inoperative position, supplying power to only the second input device.

The present invention further provides a method of operating an electronic device, said device comprising a first input device, a main body portion, a second body portion moveable with respect to the main body portion between an open and closed position, such that when in the open position the first input device is moveable relative to the main body portion between an operative and an inoperative position, and a second input device arranged to be exposed for use when the first input device is in an inoperative position and the second body portion is in an open position; the method comprising, determining whether the first input device is in the inoperative or operative position, if the first input device is in the operative position, disregarding any data received from the second input device.

Preferably, if the first input device is in the operative position, power is supplied to only the first input device. Thus, power supplied to the system is controlled.

Preferably, if the first input device is in the operative position, data from the second input device is disregarded. Thus, data flow rates are controlled. Furthermore, erroneous data input from a device, which is not being used by the user, can be deleted.

Further, the present invention provides a computer programme, which, when executed carries out the method described above.

Embodiments of the present invention are now described, by way of example, with reference to the accompanying drawings, of which:

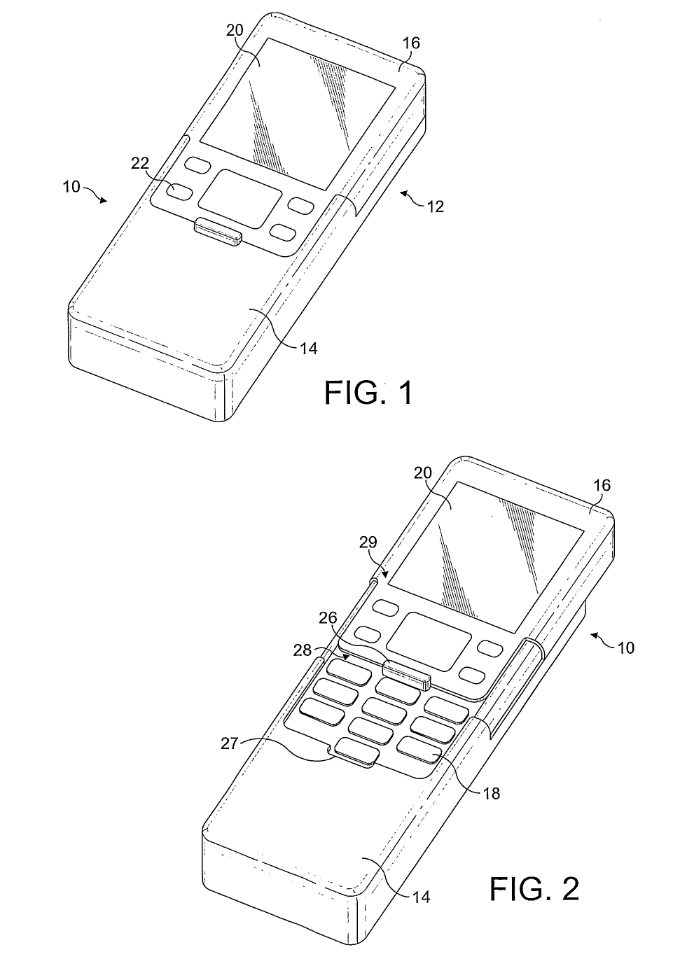

FIG. 1 is a schematic diagram of a handset embodying the present invention, being shown in a closed configuration;

FIG. 2 is a schematic diagram of the handset shown in FIG. 1 in an open configuration;

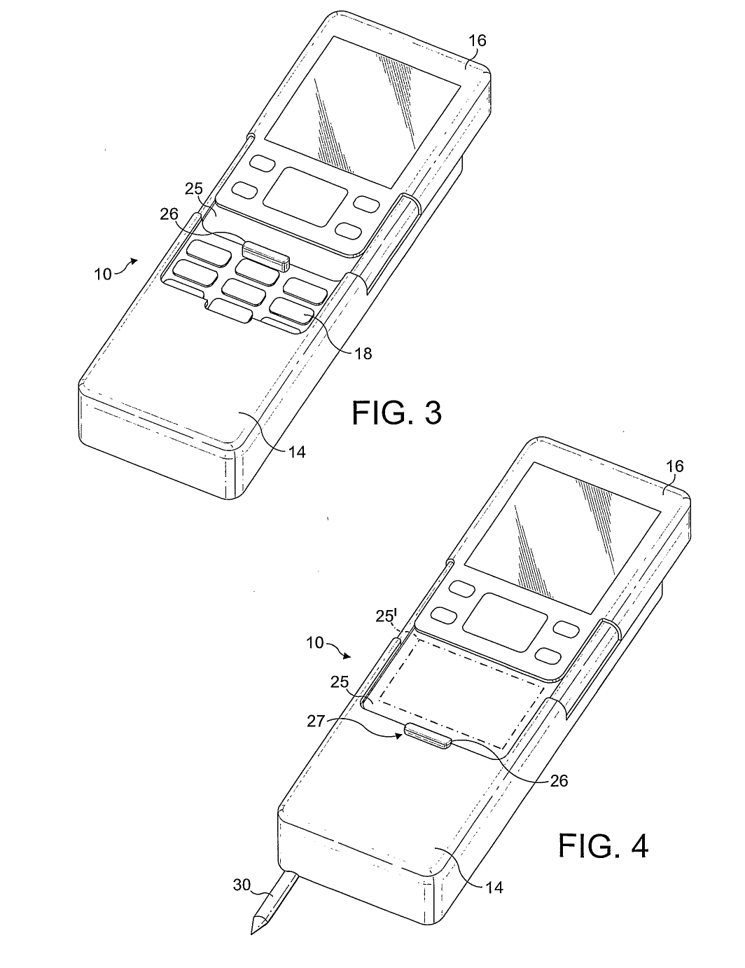

FIG. 3 is a schematic diagram of the handset shown in FIG. 2, with a second input means partially extending therefrom;

FIG. 4 is a schematic diagram of the handset shown in FIG. 2, with a second input means fully extended into an operational position;

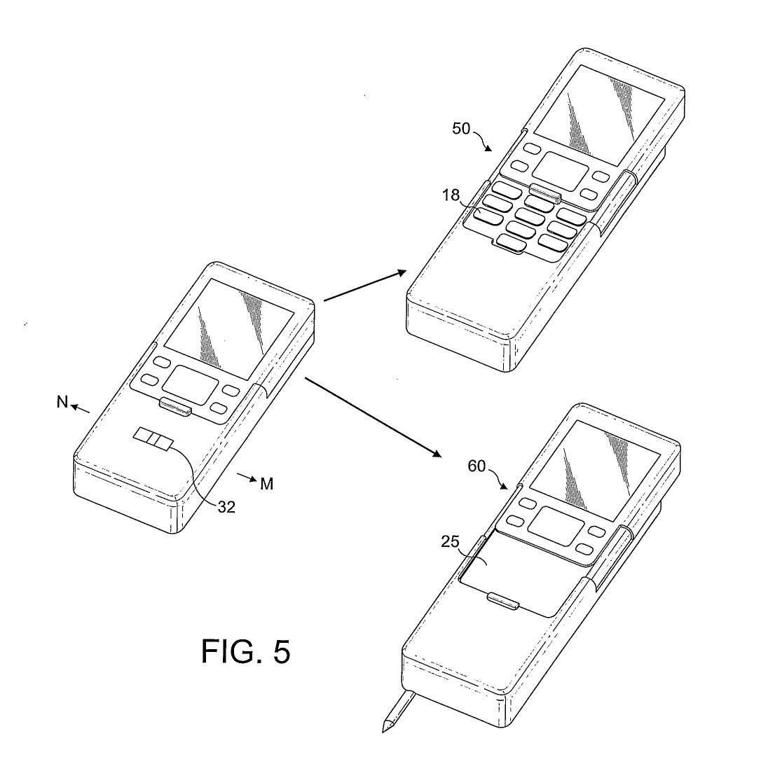

FIG. 5 is a schematic diagram of an alternative embodiment of the present invention;

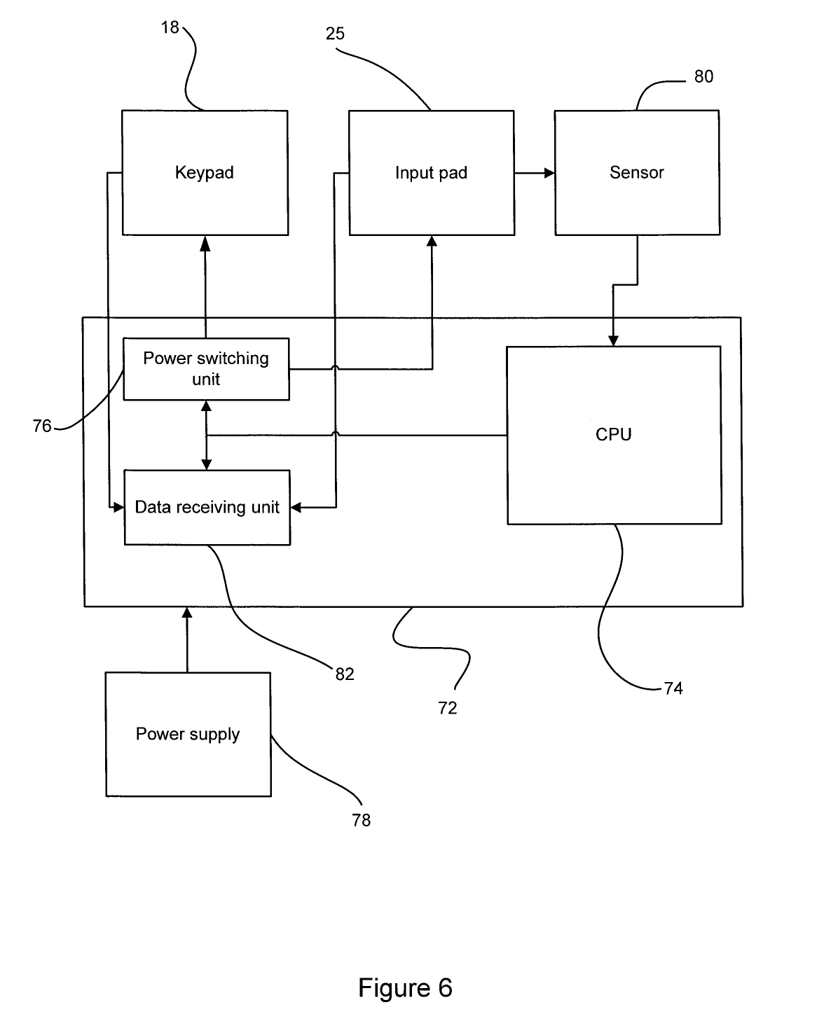

FIG. 6 is a schematic block diagram of a control unit embodying the present invention; and

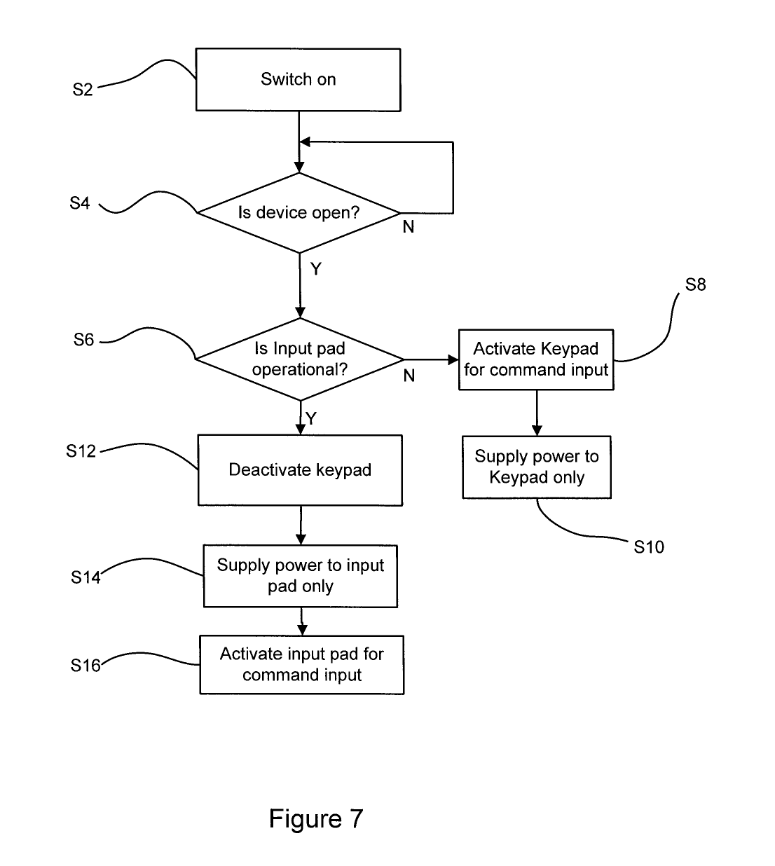

FIG. 7 is a schematic flow chart illustrating a method embodying the present invention for selecting an appropriate input means.

Throughout the drawings, the same or similar elements, features and structures are represented by the same reference numerals.

Referring to FIG. 1, a mobile phone handset 10 embodying the present invention is now described. The handset comprises a body 12 having a first, main portion 14 and second portion 16, which is moveably disposed on the first portion. The first body portion comprises a keypad 18, processor and power source (all not shown in FIG. 1). The second body portion comprises a display screen 20 and a set of pushbuttons 22. The handset shown in FIG. 1 is configured to be a slide-phone and is shown in FIG. 1 in the closed configuration; the second body portion is in a closed position.

Referring to FIG. 2, the handset 10 of FIG. 1 is shown in an open configuration; the second body portion 16 is in an open position, extending from the main body 14 of the handset. The mechanism by which the second portion is moveable between the closed and open positions is known and does not form part the present invention. When the second body portion is in the open position, a keypad 18 is exposed for use. The keypad is disposed on the main body so that the second body portion extends over the keypad in the closed position, but is adjacent to the keypad in the open position.

The handset embodying the present invention comprises a second keypad, or input pad, which is moveable with respect to either of the first or second body portions between a hidden or inactive position and an exposed or operational position.

Referring to FIGS. 2, 3 and 4, the input pad 25 is mounted on the second body portion and comprises a tang or protrusion 26 extending from a leading edge of the input pad. When the input pad is in the inactive position (as shown in FIGS. 1 and 2), the tang 26 is disposed next to an edge surface 28 of the second body portion 16 and the input pad is in the hidden position, between the first and second body portions. The tang extends from a top surface 29 of the second body portion, thereby allowing the user to manually move the input pad into the operational position from underneath the second body portion.

Referring to FIG. 4, the input pad 25 is shown fully extended from the second portion 16. The tang 26 is located in a slot 27 formed on the main body portion adjacent to the keypad. Thus, the input pad covers or shields the keypad 18 in this operational position. In this operational position the input pad is activated and data or commands can be input into the handset by the user. The input pad can be retracted into the inactive position by either moving the second body portion into the closed position, or by manually moving the input pad into the inactive position, thereby exposing the keypad for use whilst the handset remains in the open configuration.

In this embodiment, the input pad is a touch-sensitive pad, and when in the operational position, a touch area 25′ is available for use. A stylus pen 30 is used for inputting data or commands into the handset via the input pad. The pen is stored in a cavity of the main body portion 14. An ejection mechanism is arranged to couple a portion of the pen with the input pad such that movement of the pad into the operational position causes a portion of the pen to extend from the main body portion, thereby allowing access to the pen by the user. When the input pad is in the hidden position the pen is completely housed in the main body portion.

The input pad can comprise a thin LCD (Liquid Crystal Display) arranged to display contact traces of the pen as it is moved over the touch are. Furthermore, icons can be displayed on the pad. The pad is arranged to slide between the operational and hidden positions, and the touch area is completely housed in the second body portion when the input pad is in the hidden position, thereby providing a robust configuration which is ergonomic and relatively easy to handle and use. In an alternative embodiment the touch pad can comprise a so-called “scratch-pad”, similar to those employed on a laptop computer where the user's figure can be used to manipulate a screen cursor.

The handset can be configured so that the input pad is moved into the operational position automatically either by pressing a button on the handset, or when the handset is opened manually. In addition, as illustrated in FIG. 5, a bi-directional switch 32 can be disposed on the handset. The switch can be arranged so that when it is activated in a first direction M, the second body portion is moved to an open position and the keypad 18 is exposed for use (configuration 50 in FIG. 5). Activating the switch in a second direction N from a relaxed central position, results in the second body portion being moved to the open position with the input pad 25 being exposed for use, along with the stylus pen (configuration 60 in FIG. 5). In this configuration 60, the input pad can be arranged to be slid manually back into hidden or inactive position. Thus, the handset does not need to be closed and then reopened if the user wishes to change the functionality of the handset.

Furthermore, or as an alternative, the handset can be configured so that friction forces between the input pad and the second body portion are such that when the second body portion is moved to the open position, the input pad remains in the inactive, hidden, position. Alternatively, friction between the input pad and the second body portion can be arranged such that when the second body portion is moved to the open position, the input pad moves to the operational position. Furthermore, the handset can be arranged so that, with the input pad in the operational position, the second body portion can be moved into the closed position thereby moving the input pad into the inactive position at the same time.

Preferably, the input pad is manually slideable between the operational and hidden positions. As a result, the input pad requires minimal accommodation in the handset and the increased functionality of the handset provided by the input pad is achieved with minimal addition to the size or weight of the handset. In alternative embodiments, however, the input pad can be arranged so that it is moved into or from the operation position by use of a bi-stable spring or a manually operable switch-activated retraction mechanism.

The handset can comprise a control module or controller arranged to control the keypad and input pad and to control which of these input means is active at a given moment. In order to achieve this, the control module determines the position the input pad with respect to the second body portion. In other words, when the input pad is in a hidden position, the controller determines that the pad is inactive and does not supply electrical power to the pad. Furthermore, the keypad can be deactivated when the input pad is in the operational position. This arrangement can have the advantage of saving power supplied to the input means thereby maintaining expected battery life. Furthermore, deactivating the keypad when the input pad is operational results in commands or data being entered into the handset from a single source, thereby reducing the risk of erroneous data entry.

Referring to FIG. 6, a block diagram showing an arrangement 70 for controlling an embodiment of the present invention is shown, comprising a controller 72 having a central processing unit (CPU) 74 and a power supply switching unit 76. A battery 78, which may also be used to supply electrical power to the handset, supplies electrical power to the controller. At least one sensor 80 is arranged to detect the position of the input pad. In addition, the sensor, or another sensor, can also be used to determine whether the handset is in an open configuration (that is, ready for use by the user).

The CPU is arranged to control the power supply switching unit so that electrical power is supplied to the either the keypad 18 or input pad 25, depending on the position of the input pad. That is, if the input pad is in the inactive position, power can be supplied exclusively to the keypad, whereas if the input pad is in the operational position, power can be supplied exclusively to the input pad. As a result, battery power consumption rates are maintained at acceptable levels.

In addition, or as an alternative, the controller can comprise an input data switching or data receiving unit 82. Thus, the controller can be arranged to only allow data or commands to be sent to appropriate components in the handset from one of either the keypad or input pad. The input data-switching unit is controlled by the controller according to a signal received from the sensor indicating the position of the input pad. Thus, when the input pad is in an operational position, data is only received by the handset from the input pad; any data received from the keypad is ignored and/or deleted in this case. Likewise, if the input pad is in the hidden position, then only data received from the keypad is sent by the controller for further processing by appropriate components in the handset.

FIG. 7 shows a flow chart of method steps used for controlling power supplied to the input means. At step S2, the handset is activated or switched on. A sensor sends a signal to a control unit, which determines from the sensor signal whether the handset is in an open configuration (S4). If the device is closed (that is, not open) then step S4 is repeated in a loop until it is detected that the handset is in an open configuration, or until the sensor sends a signal to the controller indicating that the device has been opened.

If it is determined that the device is open (or opened), then step S6 determines whether the input pad is in an operation position. This can be achieved by utilising a sensor disposed to detect when the input pad is moved from the hidden position, or to detect when the input pad is disposed in the operational position. The sensor sends a signal to the controller to indicate when one of these conditions applies. If no signal is received from this sensor, or if it is determined that the input pad is in the hidden position, then the keypad is activated by the controller at S8 and electrical power switching unit is operated at S10 to only supply power to the keypad and not the input pad. On the other hand, if the input is determined to be in an operational position or moved from the hidden position by the sensor, an appropriate signal is sent to the controller. Then, the keypad is deactivated at S12 and power is supplied to only the input pad at S14. The input pad is then activated at step S16.

In addition, or as an alternative, the method could be arranged so that the controller transfers only data from the input pad to other components in the handset when the input is in the operative position. Likewise, when it is determined by the sensor that the input pad is in the hidden position, then the controller only transfers data received from the keypad. Thus, erroneous data entry can be minimised.

In a further embodiment, the controller can be arranged to control a stylus release mechanism, such that the stylus is released from its housed position when the input pad is moved from the hidden position, or when the input pad is moved into the operational position. For instance, the stylus can be retained in the housing by an electrically operated latch. A resilient member, such as a spring, can be arranged to urge the stylus against the latch. On receipt of a signal from the controller, the latch can be released, thereby causing the resilient member to push the stylus into a position from where it partially extends from the housing and can be removed by the user for use with the input pad. Of course, a mechanical equivalent to the stylus release system described above can be utilised as an alternative.

Further embodiments will become apparent to the skilled person without leaving the scope of the present invention, as defined in the claims. For instance, although the handset is described above with reference to a slide-phone, the invention can equally be configured on a flip-phone.

1. An electronic device comprising:
a first input device;
a main body portion;
a second body portion moveable with respect to the main body portion between an open and closed position, such that when in the open position the first input device is moveable relative to the main body portion between an operative and an inoperative position, and a second input device is arranged to be exposed for use when the first input device is in an inoperative position and the second body portion is in the open position.

2. A device according to claim 1, wherein the first input device is disposed on the main body portion.

3. A device according to claim 1, wherein the first input device is disposed on the second body portion.

4. A device according to claim 1, wherein the second input device is a keypad disposed on the main body portion.

5. A device according to claim 1, wherein the first input device is a touch-sensitive input device.

6. A device according to claim 1, further comprising a stylus for inputting data or commands to the device via the first input device.

7. A device according to claim 6, wherein the stylus is arranged to be disposed in a at least one of said main body portion and said second body portion, the stylus being moveable with respect to the device between a stowed position and a release position when the first input device is in the operative position, and wherein at least a portion of the stylus extends from the device when the stylus is in the release position.

8. A device according to claim 7, further comprising a mechanism for moving the stylus, the mechanism being coupled to the stylus and to the first input device, and being arranged so that movement of the first input device from the inoperative position causes the stylus to move from the stowed position.

9. A device according to claim 1, wherein the first input device is disposable over the second input device when the first input device is in the operative position.

10. A device according to claim 1, further comprising a manually operated actuator coupled to the second body portion such that operation of the actuator causes the second body portion to move to the open position.

11. A device according to claim 10, wherein the actuator is moveable between a first position and a second position, and between the first position and a third position, such that when the actuator is moved from the first to the second position, the second body portion is arranged to move to the open position with the first input device in the inoperative position, and when the actuator is moved from the first to third positions, the second body portion is arranged to move to the open position with the first input device in the operative position.

12. A device according to claim 11, wherein the actuator is a bi-directional switch arranged so that the first position corresponds to a relaxed position, and the second and third positions are disposed either side of the relaxed position.

13. A device according to claim 1, further comprising a sensor arranged to determine whether the first input device is in the operative position.

14. A device according to claim 7, further comprising, a sensor arranged to provide a signal when the first input device is in the operative position, said signal being usable for the moving of the stylus from the stowed position.

15. A device according to claim 2, further comprising a controller arranged to control the flow of data from the first and second input device such that only first input device data is forwarded by the controller when the first input device is in the operative position.

16. A device according to claim 14, further comprising a controller arranged to supply electrical power to the first input device and the second input device such that power is only supplied to the first input device when the first input device is in the operative position.

17. A method of operating an electronic device, said device comprising a first input device, a main body portion, a second body portion moveable with respect to the main body portion between an open and closed position, such that when in the open position the first input device is moveable relative to the main body portion between an operative and an inoperative position, and a second input device arranged to be exposed for use when the first input device is in an inoperative position and the second body portion is in an open position, the method comprising,
determining whether the first input device is in the inoperative or operative position, and if the first input device is in the inoperative position, supplying power to only the second input device.

18. A method of operating an electronic device, said device comprising a first input device, a main body portion, a second body portion moveable with respect to the main body portion between an open and closed position, such that when in the open position the first input device is moveable relative to the main body portion between an operative and an inoperative position, and a second input device arranged to be exposed for use when the first input device is in an inoperative position and the second body portion is in an open position, the method comprising,
determining whether the first input device is in the inoperative or operative position, if the first input device is in the operative position, disregarding any data received from the second input device.

19. A method according to claim 17, further comprising, if the first input device is in the operative position supplying power to only the first input device.

20. A method according to claim 17, further comprising, if the first input device is in the operative position, disregarding data from the second input device.

21-22. (canceled)
